(19) United States
(12) Patent Application Publication
(10) Pub. No.: US 2021/0010758 A1
(43) Pub. Date: Jan. 14, 2021

(54) THERMAL DEVICE WITH SAFE DISCHARGING

(71) Applicant: Hutchinson, Paris (FR)

(72) Inventors: Fabrice Chopard, Saint-Martin-d'Hères (FR); Clément Blanchard, Amilly (FR)

(73) Assignee: Hutchinson, Paris (FR)

(21) Appl. No.: 16/488,805

(22) PCT Filed: Feb. 28, 2018
(86) PCT No.: PCT/FR2018/050467

§ 371 Date: Aug. 26, 2019

(30) Foreign Application Priority Data
Feb. 28, 2017 (FR) 1751654

(51) Int. Cl. F28D 20/02

(52) U.S. Cl. CPC F28D 20/021; H01M 10/6569; F28D 20/028

(57) ABSTRACT

A thermal device comprising thermal means for dissipating thermal energy, means for thermally managing the thermal means, comprising an enclosure having a volume in which a heat absorbing substance is disposed for exchanging heat with said thermal means. A channeling is provided with which the volume of the enclosure communicates in order, in an abnormal overheating situation of the thermal means to discharge at least part of said substance to the outside that is further away from the thermal means than said volume is.

### BACKGROUND OF THE INVENTION

### 1. Field of the Invention

This invention relates to thermal management by means of substances, the latent heat of which is used, such as PCM substances, also called Phase Change Materials.

### 2. Description of the Related Art

PCM refers to a substance, the physical state of which can change within a limited temperature range. The thermal storage can be achieved by using the Latent Heat (LH) thereof: the material can then store or transfer energy by simple change of state, while maintaining a temperature and a substantially constant pressure, that of the change of state.

Thus, in particular, a thermal barrier located around or along at least one part of at least one thermal means which can heat excessively and/or between at least two such thermal means, is targeted here in order to facilitate the control of an inappropriate temperature rise of this (these) thermal means.

US 2016/0229622 discloses a thermal barrier that extends around such “thermal means”, the barrier comprising:
optionally a first element containing at least one PCM material,
and at least one thermally insulating element.

In US 2016/0229622, the problem of controlling an inappropriate temperature rise of thermal energy dissipating means does not arise, since there is not supposed to be a high heat production to be controlled to avoid a runaway operation of these thermal means and/or a functional device of which they could be a component. In addition, the above-mentioned thermal barrier defines an enclosure between the internal volume (with the thermal means contained therein) and an outside environment where excessive heat is not expected to prevail.

In addition, from US2016264018 A1 a thermal device is known which comprises:
at least one said thermal energy dissipating thermal means, in operation,
means for thermally managing said thermal means comprising an enclosure having a volume where a heat absorbing substance is disposed for exchanging heat with said thermal means then in a nominal operating situation, and
a communication, also called channeling (identified 205, 206 in this document), between the volume of the enclosure and the outside environment.

In a conventional way, “nominal” refers to a characteristic, a performance of an apparatus (here said thermal means), announced by the manufacturer or provided for in the specifications.

More specifically, for the thermal management in a nominal operation (15 to 50° C. typically) of an electric storage battery assembled within a rigid enclosure, thermal storage means integrated into this battery are provided, which include an enclosure containing a solid/liquid PCM and having a volume of heat exchange with said accumulators. This volume is delimited by at least part of the enclosure. And the enclosure is equipped with an expansion vessel capable of absorbing the expansion of the PCM as it passes into the liquid phase. The expansion vessel has an internal volume that extends the heat exchange volume of the enclosure.

However, the problem that has arisen for inventors is linked to the control of an abnormal rise in temperature of one or more thermal energy dissipating thermal means, excluding nominal operation.

The term “thermal means(s)” is to be considered as referring to functional elements (such as cells of a storage battery) which, in operation, can individually heat excessively and thus risk negatively affecting the operation of such adjacent thermal means, or of themselves continuing to thermally drift until damaged or destroyed.

But the term “thermal means” also covers an element of an associated functional device, such as one or more fluid(s) that will circulate in an internal volume and for which it would be necessary to regulate/control an inappropriate temperature increase (e.g. water, air or oil, on a water, air or oil circuit of a vehicle driven by an internal combustion or electric engine).

Especially on such a vehicle, the outside environment where the vehicle is located, and therefore with which the “thermal means” and its associated thermal management means are confronted, can be at a high temperature, 50° C. or even higher. The excess heat produced in said internal volume may then not be discharged. In addition, between two thermal means (e.g. two contiguous fluids in circulation or two adjacent cells of a battery), an excessive heat transfer problem from one to the other may occur.

### SUMMARY OF THE INVENTION

The invention aims to solve at least some of the above noted problems and proposes to this end that the above-mentioned thermal device from US 2016264018A1 be such that said channeling between the volume of the enclosure and the external environment defines a discharge allowing (through which), in an abnormal overheating situation of the thermal means, that—towards this external environment and further away from the thermal means than said volume is—at least some of the heat absorbing substance is discharged.

Thus, the solution of the invention differs from that of US 2016264018A1:
which deals exclusively with the nominal operation of a battery,
which has no PCM discharging to move this PCM away from the thermal heat producing means (the accumulators),
and which, on the contrary, provides for the PCM to be kept in permanent contact, in particular with the entire heat exchange surface which forms the interface between the PCM and the accumulator enclosure, in the storage volume, in the solid phase of this PCM, and in this volume as well as in the curved “expansion vessel”, in the liquid phase of the PCM.

The solution presented above provides, in case of overheating (and therefore not nominal) operation of the thermal means, to discharge towards the outside the heat absorbing substance, thus reducing the PCM/thermal means heat exchange surface.

In the invention, the aim is to remove the excess heat generated.

With the above solution, it will be possible both to maintain an optimized heat exchange during the nominal operation of the thermal means (in its controlled temperature range) and to limit the risk of the thermal means running away from it, in an abnormal overheating situation, by evacuating at least part of a substance loaded with calories.

In view of its effectiveness, it is further proposed that said heat-absorbing substance should be a suitable latent heat storage element:
to absorb by phase change a quantity of heat dissipated by the thermal means, and
to be evacuated through said discharge, in a fluid state in which it has changed, above a predetermined temperature, during the phase change.

Since we are then in critical operation (a failure event) and at least if the “thermal means” is a battery (or one of its cells), said predetermined temperature will then be favourably between 70° C. and 130° C. (within 10° C.).

In order to be able to adapt the time of the above-mentioned discharging, it is proposed that the volume of the enclosure or each enclosure communicates with said discharge through a communication that can be closed, such as a pellet that breaks under generated vapour pressure, a wall that opens or is opened (e.g. by pressure tearing or temperature increase: thermal destruction), in the abnormal overheating situation of the thermal means, or a valve.

Because of this planned discharging “to the outside” of at least part of said heat-absorbing substance, the nature of this substance has also been worked on this aspect.

Therefore, it is recommended that the fluid phase in which the latent heat storage element is changed, above said predetermined temperature, should be a gaseous state.

A gas is easy to discharge, naturally. And by condensing it, one can get it back, further away. The changing temperature thereof from a liquid is high.

In the above-mentioned application, the temperature range between 70° C. and 130° C. (within 10° C.) will therefore be the one in which a suitable PCM block will gradually change from a liquid to a gas state by boiling. Below 70° C. (within 10° C.), the PCM will be totally liquid.

According to another approach, it is proposed that said heat-absorbing substance should be capable of being in such a gaseous phase so that, in said abnormal overheating situation of the thermal means, it can be evacuated in said gaseous phase to the outside through said discharge.

The advantages will be the same and it will then be possible, for example, to choose a liquid/gaseous PCM that is not particularly harmful to the environment, such as a water-based mixture.

It is in this context that said discharge is provided to communicate with a higher part of the volume of the enclosure concerned In this way, the gaseous PCM vapours will be easily collected and discharged.

Since it should be typically interesting to apply the solution presented here in conjunction with overall thermally managing the thermal means, therefore including in the nominal operating phase (i.e. in the normal operating temperature range of 25 to 35° C. for battery accumulators), it may be considered useful for said thermal management means to also include first and second latent heat storage substances arranged on either side of the volume of said enclosure as a “thermal fuse” function.

Typically, these first and second latent heat storage substances will be able, for such a “battery” application, to accumulate at least part of the thermal energy dissipated by the accumulators by ensuring a phase change around 35° C., within a few degrees.

This will ensure that the battery temperatures are smoothed before any thermal drift occurs.

A relevant solution will then be for the thermal device:
to itself include at least two of said thermal means,
and for the thermal management means to further comprise first and second latent heat storage substances respectively disposed between said volume of the “thermal fuse” enclosure and the thermal means.

In this case in particular, it may typically be of interest for the thermal management means to also include at least one thermal insulating element interposed between the thermal means and the enclosure containing the heat absorbing substance.

Thus, in the event of a thermal runaway of a first thermal means while for example a second such means is in nominal operation, it will first be possible, with the thermal insulation, to prevent the excessive thermal energy dissipated by the first means from reaching the second one, then, beyond this barrier, to let the “thermal fuse” act, which will first absorb at least part of this energy and then discharge it away, a priori in a non-reversible way, via this planned discharging of a part of the heat absorbing substance.

The opposite could also be provided for: at least two said enclosures containing the heat-absorbing substance arranged on either side of a thermal insulating element, between two said thermal means.

In this case, in case of excessive temperature rise, the “thermal fuse” will act first, then the thermal insulation. This solution is more thermally efficient.

To discharge at least part of the heat-absorbing substance away not only from the thermal means, but also from the volume that contained it in nominal operation of the system, it is possible to provide one then locally open enclosure, to present:
a low discharging, in order to let a part of the substance that absorbs heat flow by gravity if it is liquid then,
and/or a high discharging to, if it is gaseous then, allow this gas to escape.

Pipes can guide the escaping substance.

It is also proposed that the thermal device might include two such shells:
in the volume of each of which will be placed one said heat-absorbing substance,
and in which volume the thermal management means will further include a communicating vessel system which will include a communication pipe communicating said volumes of said two shells.

To allow:
this communicating vessel system to be easy to manufacture and install, and to operate very efficiently, even if the system is not present, and
a liquid-phase heat-absorbing substance to escape from said volume containing it as long as its temperature is not significantly above said limit temperature,
   it is proposed that each enclosure should be open at the bottom for possible displacement, in or out of said volume, of the heat-absorbing substance contained in the liquid phase, and this in the nominal operating situation of the thermal means, which is then less hot than the abnormal overheating situation.

However, the above does not strictly require that the heat-absorbing substance is always in liquid phase until the abnormal overheating situation has been reached: the heat-absorbing substance could be in solid phase at the lowest operating temperatures of the thermal means.

And, to allow a gas-phase heat-absorbing substance to escape from said volume in an overheated situation, it is proposed that each enclosure should be open at the top.

In both cases, an advantage will be to allow a natural movement of the heat-absorbing substance in the phase in which it is located.

In addition to the above device, a method for thermally managing at least one thermal means dissipating thermal energy during operation is also concerned.

For the same considerations as above, it is proposed:
that the following are placed close to each other:
   said at least one thermal means,
   means for thermally managing the thermal means, comprising at least one volume where a phase-change latent heat storage substance is disposed for exchanging heat with said thermal means while it is in operation, the latent heat storage substance having a boiling temperature at atmospheric pressure above which it passes into a gas state, and
   an above-cited channeling between the volume of the enclosure and the outside environment,
to anticipate that the thermal means may operate in an abnormal overheating situation, at a temperature higher than the boiling temperature at atmospheric pressure of said latent heat storage substance, and
that, during one said abnormal overheating situation, by means of said channeling and at this temperature above said boiling temperature at atmospheric pressure, an exhaust of the gas in which the substance has changed is ensured.

It will be understood that “possible” means that the event was anticipated as possible and its consequence was anticipated and managed to avoid the destruction of the thermal device, via the above-mentioned use of a “high temperature thermal fuse”.

### BRIEF DESCRIPTION OF THE DRAWINGS

An additional description for the realization of the means used here is provided below, with reference to the attached drawings where:

FIG. 1 is a section along line I-I of FIG. 2 showing the inside of a housing accommodating electric accumulators thermally protected by the device of the invention,

FIG. 2 is an external perspective view of the elements shown in FIG. 1,

FIG. 3 shows the installation of the electric accumulators thermally protected by the device of the invention in the housing that can receive them,

FIG. 4 is a detailed perspective view of the electric accumulators or cells separated in pairs by thermal management elements used in the invention,

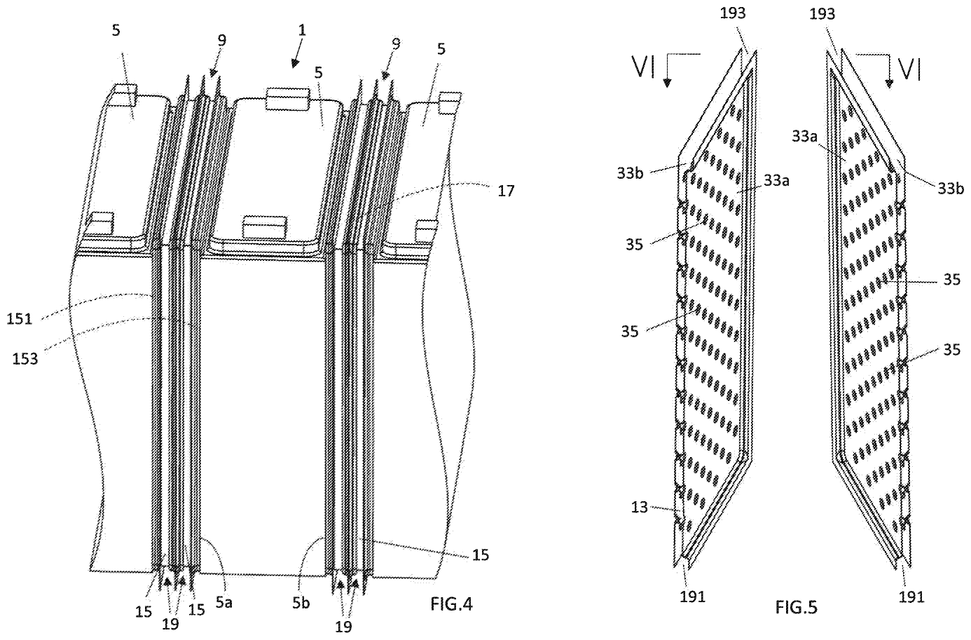

FIG. 5 shows a possible construction of two metal lateral enclosures each intended to contain one said heat-absorbing substance with, between them, a complementary enclosure to be welded peripherally after having placed a thermal insulator and having, if desired, established a primary vacuum,

FIGS. 6 and 7 show two subsequent states, after welding (FIGS. 6.7) and then with the two metal lateral enclosures filled with said heat absorbing substance (FIG. 7),

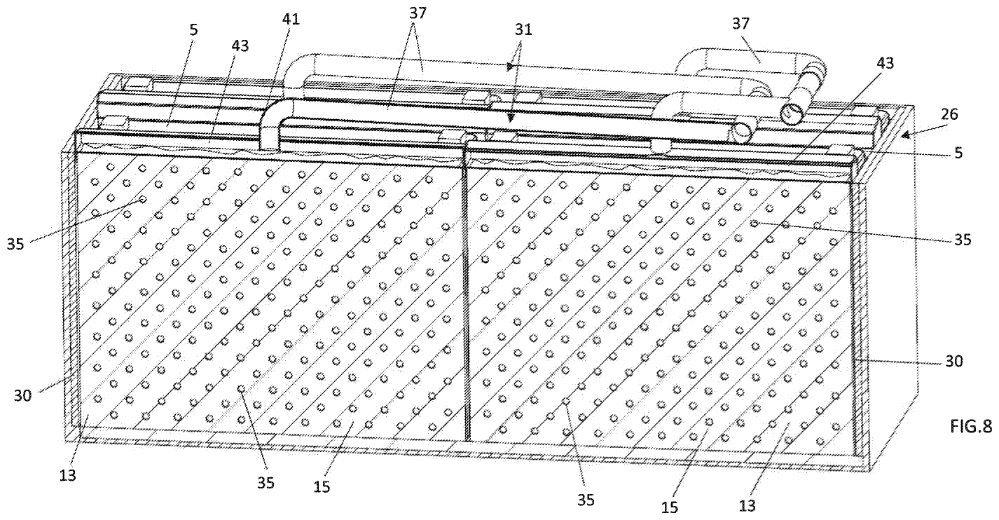

FIGS. 8-9 are sections along lines VIII-VIII and IX-IX, respectively, in FIG. 2,

FIGS. 10-11 are two transverse sections, as FIGS. 1.9, but more local and corresponding to a variant of the solution shown in FIGS. 1-3.8.9, in two states, respectively, while the heat absorbing substances (15 below) are still exclusively in the internal volumes 13 of their respective enclosures (19 below) (FIG. 10), and escape from them (FIG. 11),

FIGS. 12-15 show an enclosure open at the bottom and selectively closed at the top, along the cut lines XIII-XIII and XV-XV, for FIGS. 13.15, respectively, and

FIG. 16 is a local enlargement of FIG. 13, with the enclosure selectively open at the top (the wall 51 below).

On the figures, some dotted lines attached to the markers indicate that the means concerned is not necessarily visible on the illustrated figure, but is present, hidden.

### DETAILED DESCRIPTION OF THE PREFERRED EMBODIMENTS

The figures show an application of the thermal device 1 of the invention to thermally manage a battery 3 typically intended for an electric or hybrid vehicle, although a thermal vehicle battery may also be involved.

As already mentioned this is only an exemplary application. Indeed, for example in an oil/water or liquid/gas heat exchanger in a vehicle, it may be necessary to avoid the risk of an inappropriate temperature rise via the “thermal fuse” proposed here.

In the application case illustrated and detailed below, the battery 3 includes several accumulators or cells 5 aligned and connected together to create an electrical generator of desired voltage and capacity, the electrical connections of which have not been illustrated either between themselves or with the environment (connection terminals for distributing the electricity produced). The electrical terminals for connecting the cells 5 are marked 50a, 50b.

Moreover, we have not represented here the possible case where a thermal device 1 with “thermal fuse” 7 would be placed around all the cells 5 to try to regulate/control an inappropriate temperature rise on the periphery of the battery, between the cells 5 considered as a whole and the outside.

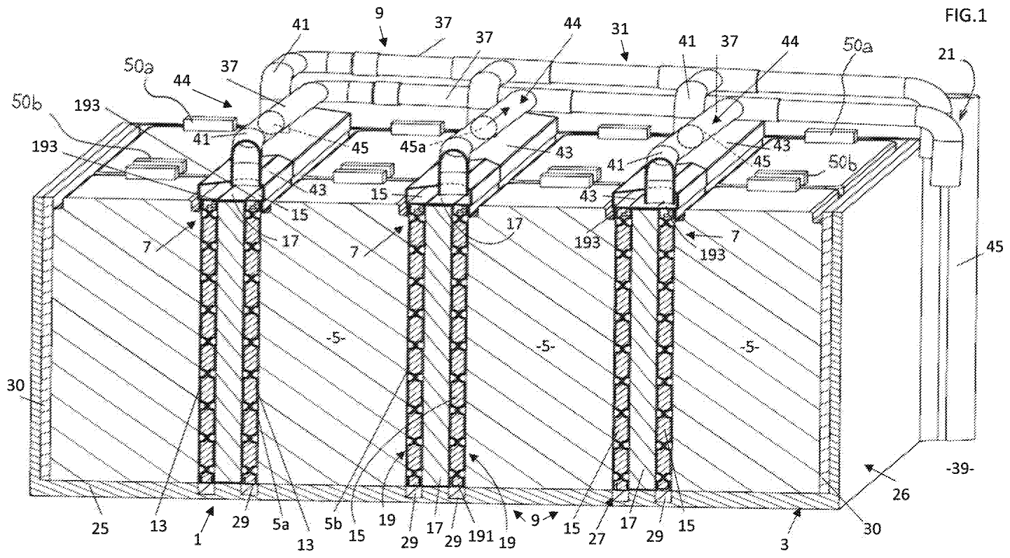

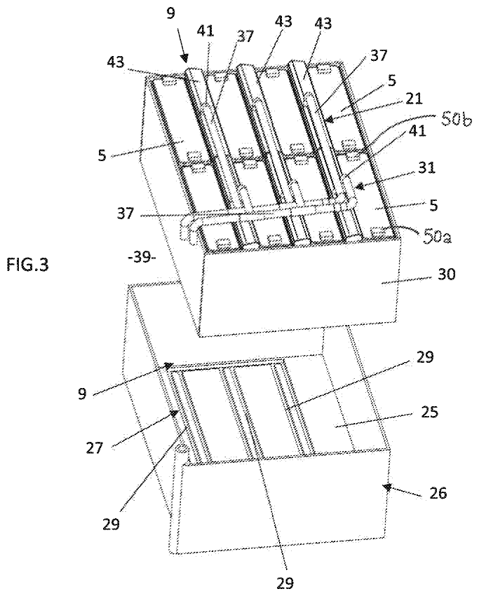

Indeed, the examples presented provide that around these cells 5 considered as a whole, several elements with latent heat storage material (s) 30 (FIGS. 1, 3, 9 in particular) and/or at least one layer of thermal insulation (for example a super-insulation based on silica aerogel) preferably placed in a partial vacuum enclosure, of the PIV (vacuum insulating panel) type, are arranged as complementary elements belonging to the thermal management means 9. All this can be placed in an upwardly open housing 26.

The following is therefore applicable to this case, respecting the proposals made above with the following additional explanations if necessary.

The heat exchanger 1 comprises:
at least one cell 5, as a thermal means dissipating thermal energy, in operation,
and means 9 for thermally managing the cell(s) 5.

In the following, since the cells are (arbitrarily) assumed to be flat, they each have two opposite sides 5a.5b.

At least some of the means 9 comprise an enclosure 19 having an internal volume 13 where a heat absorbing substance 15 is arranged for exchanging heat with said thermal means 5 while it is in nominal operating condition.

In the case of the battery 3, this situation will be one where cells 5 produce electrical energy at a temperature typically evolving between 15 and 60° C., preferably between 25 and 35° C.

For this purpose, it may be provided that the thermal management means 9 comprise, between two (faces of) successive cells 5, or on at least one side of such (face of) cell, at least one thermal insulating element 17 and/or in addition at least one, and preferably two (one per face) latent heat storage substance(s) 15.

Preferably, and even if, for example, water (sometime not listed as PCM in the literature) could be used, each substance 15 will be a PCM. And preferably, and especially if it is a PCM, each substance will be either a solid/liquid/gas phase substance or a liquid/gas phase substance.

A priori it will be advantageous to use the second solution (liquid/steam phase substance) compared to the first one, allowing to aim at an improvement of the exchange coefficient via the boiling regimes, a possibility to ensure a fluid circulation between the different volumes, a much more important phase change enthalpy (for water for example).

For a solid/liquid/gas phase PCM, a fluid phase could be mixed with a micro-encapsulated phase change material. Such fluids using paraffin exist. However, a set of materials could also be micro-encapsulated to create a more or less viscous liquid and more or less loaded with PCM, with improved thermal storage properties thanks to the addition of PCM. Water can also be mentioned as a fluid phase, which should be set in motion to avoid stratification of the micro-capsules and/or deposition that could block the pipes 29.

In addition, phase change PCM materials can be partially or non-integrated into a fluid such as water: a paraffin, a hydrated salt, a lipid derivative, an eutectic.

In each case, in the hottest phase, the fluid will be used to discharge excess calories with it, outside the internal volume 13.

Each enclosure 19 will be adapted to be able to lose a part of the contained substance, preferably at least at a predetermined temperature higher than or equal to the maximum of said nominal operating situation of the battery (the so-called substance limit temperature 15), thus at a time when an adjacent cell 5 will start to heat excessively, due to a malfunction.

Thus, for example, around 60 or 70° C. (liquid solution) or even higher (gas solution), while the temperature of at least one of said thermal means 5 is higher than said limit temperature of the substance 15 at which it changes state, the substance 15, depending on whether it is then in liquid (if it was previously solid) or gaseous phase, will be allowed to flow out of said volume or to be discharged through a gas exhaust. The volume 13 will then empty itself of part of said substance.

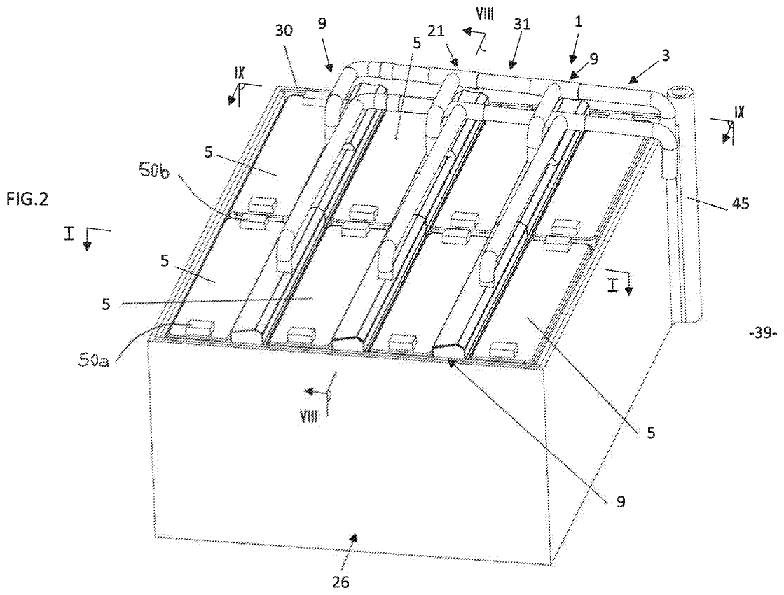

For this purpose, each volume 13 of the enclosure 19 communicates, at least at this time, with a discharge duct 21 to discharge to the outside (31, FIGS. 1-3), through this discharge duct 21, at least a part of said substance 15 which is then still contained therein, and therefore a part of the heat absorbed until then by the substance, in said abnormal overheating situation of the thermal means 5.

Compared to the volume 13, this discharging to the outside of at least part of the substance 15 having changed state has the effect of removing the discharged part from the thermal means 5.

The expression “discharge duct” is to be understood in the broad sense as any means by which the substance 15 loaded with thermal energy and therefore in a fluid phase can flow, or be discharged by gas exhaust, out of the volume 13.

Thus, it could be expected that the enclosure 19 would be locally made of a material that would be liquid-tight up to a maximum temperature (e. g. 70-80° C.) and would then lose this sealing, for example by local disintegration or rupture of an area of lower mechanical strength, in order to allow the liquid or gas to pass through a part of said substance 5 thus changed.

However, this is not the case in the lower part of each enclosure 19, in the preferred version illustrated and described below.

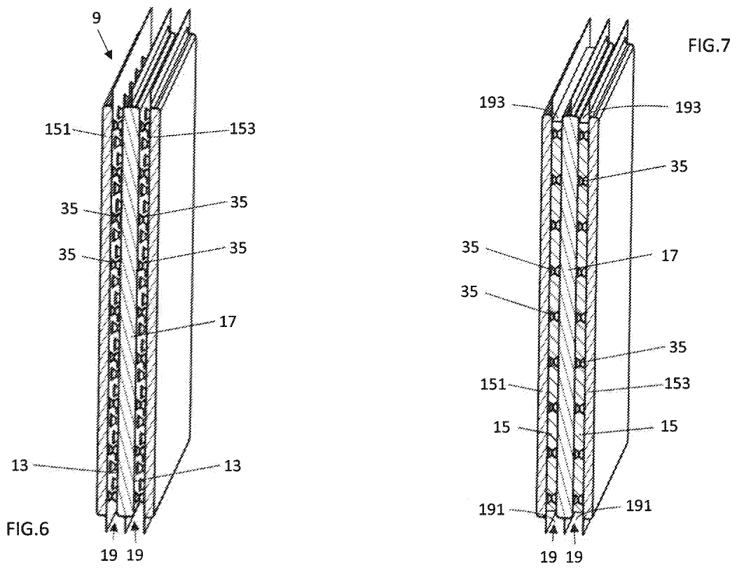

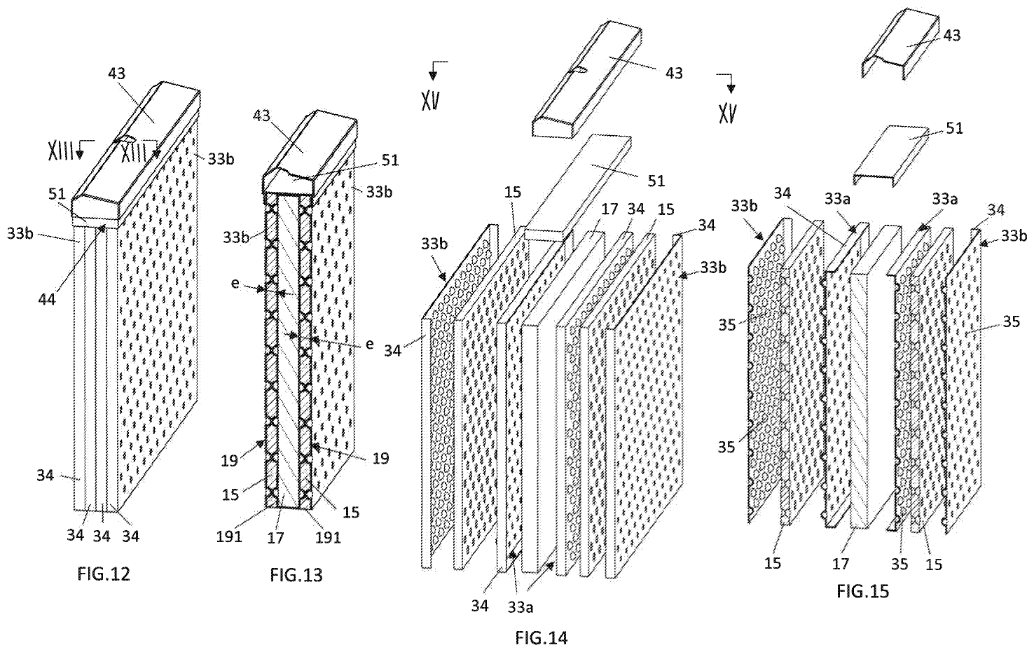

Indeed, as shown in FIG. 5 for example, one solution may be for each enclosure 19 to be, as manufactured, open in the lower part 191 for a possible displacement, outside said volume 13, of the heat absorbing substance 15 that the enclosure contains, when the substance is in a liquid phase. The above-mentioned sealing up to a maximum temperature may then only be provided for in the upper part (193 below; see FIG. 12-15) of the volume 13 considered.

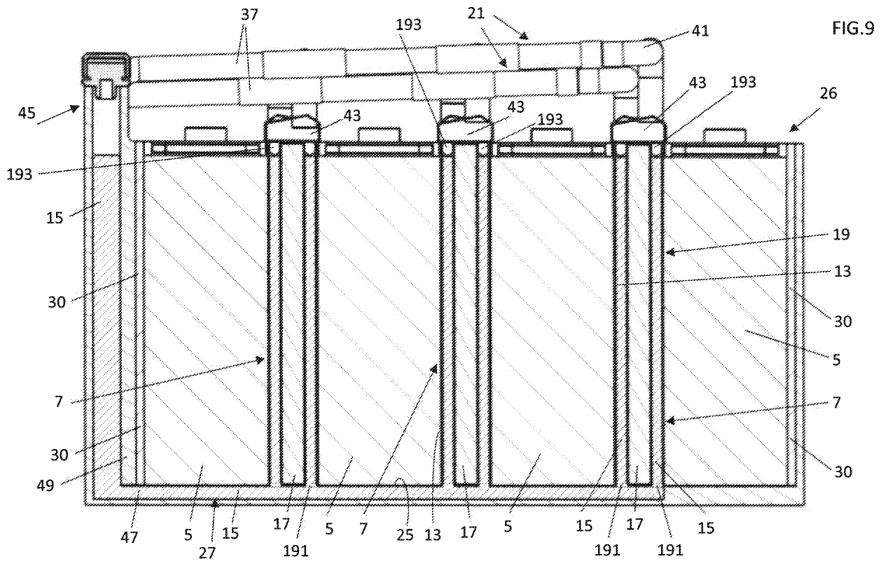

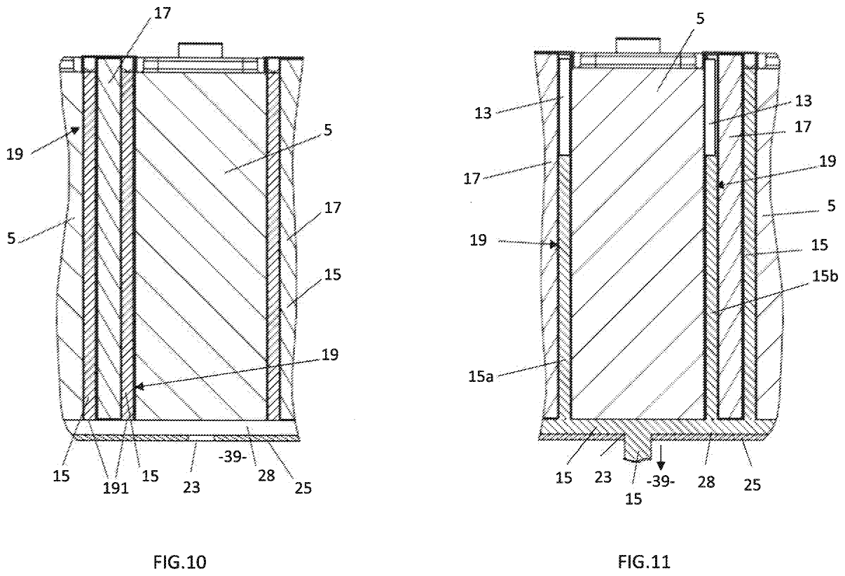

The opening at least in the lower part 191 will be particularly suitable, if the substance 15 has a liquid phase, the lower opening 191 can then communicate with a channeling 23 crossing the bottom 25 where the thermal means 5 between each pair of which the substances 15 are interposed in their enclosures 19, as in the embodiment of FIGS. 10-11 which is therefore a variant of the solution illustrated in FIGS. 1-3, 8, 9. FIG. 10, the substances 15 are still solid and exclusively contained in their enclosures 19. FIG. 11, two said heat-absorbing substances, respectively 15a-15b, are liquid and have flowed by gravity to an external channeling 23. Levels in the two corresponding volumes have decreased. If it is necessary to avoid drilling too many channelings 23 in the bottom, one or more channel(s) 28 provided at the bottom 25 will be able to connect the open lower parts of the enclosures 19 to each other, in particular so that any liquid flows of several substances 15 in the event of overheating of several thermal means 5 are collected in these bottom channels and guided towards a common channeling 23.

FIGS. 1-3, 8, 9, but also 11 to 15, the opening at the bottom 191 of each enclosure 19 is used in another way, especially in the case where (or because here) the substance is a liquid/gas phase change substance.

Indeed, while several enclosures 19 with substances 15, each open at the bottom 191 are arranged in the case 26, a communicating vessels system 27 which includes communication pipes 29 making said volumes 13 of the enclosures communicate with each other is provided towards the bottom 25 of the case 26.

The pipes 29 can be channels open upwards in the bottom 25 under the open volumes 13 and extending between them.

Thus, it will be possible, whereas two substances 15 are at least partially liquid, to make them communicate in such a way that if at least one of them heats up and already partially passes into the vapour phase, the drop in the level of the liquid in a volume 13 can be compensated according to the principle of communicating vessels.

For this purpose, the enclosures 19 may not have been completely filled (up to the top) with substances 15.

A possible useful aspect in combination with this system of communicating vessels (but which can therefore be dissociated from it) relates to the steam exhaust system, or means, preferably provided for in addition.

Indeed, if, in a situation of excessive heating of at least one thermal means 5, an adjacent substance 15 changes phase, and thus becomes at least partly gaseous when it has been loaded with thermal energy, its discharging by steam exhaust from the volume 13, which until then contained this liquid substance, will cause a drop in the level in said volume. However, if the system of communicating vessels is coupled to this possible steam exhaust, the levels in the volumes thus connected will then balance out.

To allow more generally the above-mentioned steam exhaust by a discharge 21, it is provided in the example in FIGS. 1-3,8,9 that (the volume of) each enclosure 19 will be open or openable in the upper part 193 for a possible displacement, out of the volume 13, of the substance 15 considered that the enclosure contained when the substance was in the liquid phase.

To open an enclosure 19 in the upper part 193 and/or lower part 191, it can be made as two for example metallic, walls 33a, 33b erected face to face, with spacers, such as stamped sheets, 35 maintaining a distance between them to store the latent heat storage substance 15, as shown in FIG. 5 or 12-15.

The distance (FIG. 13) between the walls 33a, 33b will allow, at the bottom, a communication with the exhaust chanelling(s) 23 and/or 28 or 29 and therefore possibly the communicating vessels system 27. In the upper part of 193, this gap will allow a connection to the steam exhaust system 31.

In the example in FIG. 5, shown in FIGS. 13,14, two double walls 33a,33b are fastened together at their respective edges or flanges 34, fully peripheral for the two central walls 33a intended to seal the insulation 17 and only lateral for the two side walls 33b to be fastened (e.g. welded) each to the adjacent central wall 33a, as shown in FIGS. 12,13,14,15.

In the example in FIGS. 1-3,8,9, preferred because it is simple and efficient, the system 31 includes collection tubes or pipes 37 connecting the upper parts 193 with the outside 39 of the device 1 (and in the example of the battery).

Thus, the vapours or the gaseous phase from a previously liquid substance 15 will be able to escape from each volume 13 concerned where thermal energy from overheated thermal means 5 has therefore been stored in the first instance. This exhaust will carry with it a part of said thermal energy stored in this way.

Preferably, to prevent substance returns 15 in the event of condensation in the collection tubes 37, the latter should be inclined downwards, to the outside environment 39, beyond an upper bend 41.

Between the collection tubes 37 and each open upper part 193, downwardly open shrouds can extend along and above these openings and thus collect and guide the gas to its external discharge.

For each substance 15, it may therefore be a PCM substance or material (in its common technical-commercial sense) which will preferably be of the solid/liquid or liquid/gaseous type. In the example, a hot phase change (melting in the solid/liquid case) around 60-70° C. is expected.

In any case, PCM or not, each substance 15 will preferably have, to act as a thermal fuse element as required, one of a phase change (or transition) enthalpy of 60 kJ/kg or more under atmospheric pressure and at the phase change (or transition) temperature of the PCM.

If it is solid in a phase, it will be in this phase that the concerned substance 15 can be placed in the enclosure 19 during manufacture. Alternatively, an external buffer tank 45 can be provided, connected to the volumes 13 for example via the channels or the pipes 29, via at least one intermediate pipe 47 passing through at least one side wall 49 of the housing 26, as shown in FIG. 9. This tank system could be used in the variant of FIGS. 10-11, via the bottom channels 28 and in the hot, liquid state of the substances 15, for the volumes 13 that would then be filled. The discharge pipe 23 would then have to be selectively plugged.

In particular for safety reasons and/or to control the circulation of the substances with respect to their volumes 13, in (liquid or gaseous) states that allow it, it is proposed that each volume 13 will communicate with the discharge (21, 31; 23, 28) through a channeling 44 that can be closed.

Two practical solutions have been developed in particular, in the case where the substances 15 have a gas phase and escape through a steam exhaust system, such as 31 for example.

For example, FIG. 1 shows that the valves 45 or 45a are provided on the steam exhaust system, typically in the vapour collection tubes 37 of the substances 15. Each valve will be advantageously closed, in said nominal operating situation of the adjacent thermal means 5 concerned. If a thermal means 5 overheats and thus passes into an abnormal operating situation, the adjacent substance(s) will vaporize at least in part. Let us suppose that this is the case for the two central substances, FIG. 1. The valve 45a will then open and the steam can escape to the corresponding external discharge pipe.

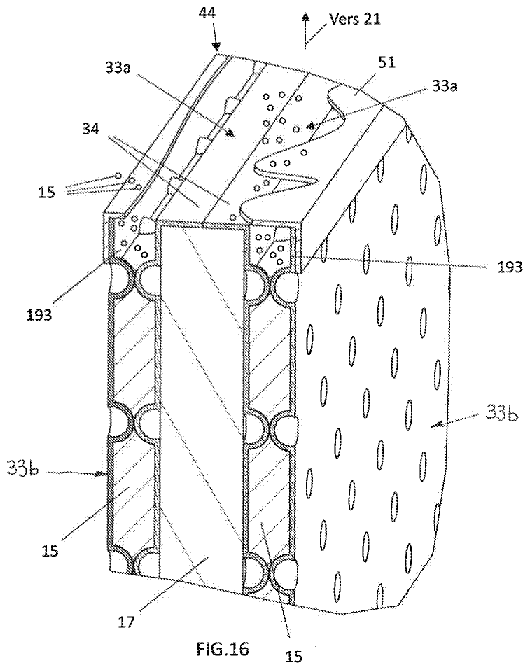

Other possibility illustrated in FIGS. 12-15: The channeling 44 which can be closed comprises at least one wall 51 which seals the upper part 193 of each volume 13 of the enclosure 19 concerned, in said nominal operating situation of the thermal means 5, and which, in the abnormal overheating situation of the same thermal means 5, allows the substance 15 to pass towards the discharge 21; see FIGS. 13 and 16 in particular.

In the case of a liquid/gaseous phase substance 15, the wall 51 will be advantageously liquid-tight but gas-permeable.

It will also, and preferably, be adapted to open shortly after the substance 15 has become at least partly gaseous in the volume 13 concerned.

Its selective permeability will allow hot gases to pass through to the discharge 21, even before it opens if this is the case.

And its aforementioned ability to selectively open will allow it to let a wide passage for said hot gases escaping to the discharge 21, even if it is not permeable to gases.

The selective opening of the wall 51 may be achieved by local disintegration of its material (e.g. it may melt) or by breaking off an area of lower mechanical strength, under given pressure and/or temperature conditions.

Thus, at a predefined temperature higher than the temperature at which the substances 15 change from liquid to gas and/or corresponding to the beginning of overheating of the thermal means 5 (beginning of their so-called abnormal overheating situation), can the wall 51 melt or tear, for example under pressure.

In this way, it will have been avoided that, in the event of switching or tipping of the device 1 and/or the thermal means 5, the substance 15 has unexpectedly spread, typically by flowing freely into or out of the steam exhaust system 31, even though the latter (and in particular the shroud 43) is fixed in a liquid-tight manner.

In addition to substance(s) 15 provided for as above, the thermal management means 9 may include additional latent heat storage substances 151,153, called first and second substances and arranged on either side of one said volume 13 and therefore of the corresponding enclosure 19.

Thus, between two successive thermal means 5, two additional substances 151,153 can be found interposed, framing at least one volume 13 of the substance 15.

These additional substances 151,153 may be made of a PCM material, which shall preferably be of the solid/liquid or solid/solid type, with a change of phase or hot crystallization (melting in the solid/liquid case) at a temperature lower than that of the above-mentioned substance 15.

Thus, the phase change allowing the additional substances 151,153 to store latent heat from the energy dissipation of the thermal means 5 will occur at a temperature lower than the corresponding phase change temperature of said substance 15.

This additional substances 151,153 change temperature will be favourably between 15 and 60° C., preferably in the range of 28-38° C., for application to the battery 3, provided that it is therefore planned with a nominal and optimal functioning between and 35° C., within 10%.

The same may apply to the element(s) with latent heat storage material(s) 30.

Thus, it is possible to provide:
with at least one (block of) said substance 15 passing from a liquid to a gas between 70° C. and 130° C. (within 10° C.),
and additional bodies 151,153 and/or latent heat storage material(s) element(s) 30 the transition of which, such as a change from a solid to a liquid state, will be between 15 and 60° C., is preferably between 15 and 45° C.

Thus, before the substances 15 play their role as thermal fuse elements, the additional substances 151,153 will have intervened by changing the phase and storing latent heat from the thermal means 5, in order to prevent their runaway beyond their nominal operating temperature range.

As for the thermal insulation 17, which is also placed between two successive substances 15, it will thermally protect one of these substances if the other heats up excessively.

Each thermal insulation 17 could be a plate-shaped element, such as a foam or aerogel in a matrix, and therefore be placed in an air-vacuum sealed enclosure formed by two vertical walls 33a joined together to define a VIP (Vacuum Insulation Panel); see FIGS. 12-15.

As regards the thermal insulation 17/substance 15 combination(s) as a thermal fuse element, two assemblies are more particularly considered.

In the first case, a substance 15 filling at least essentially the corresponding volume 13 is interposed between two thermal insulations 17 themselves therefore interposed between two successive thermal means 5, (with possibly two additional substances 151,153 interposed respectively between the thermal insulations 17 and the thermal means 5).

The advantage is then to improve the prevention of thermal transfer from one substance 15 to another, via these two insulating barriers 17.

In the second case, a thermal insulation 17 is interposed between two substances filling at least essentially the corresponding volume 13, themselves therefore interposed between two successive thermal means 5 (still with the two additional lateral substances 151,153 if necessary).

The advantage is then to offer each thermal means 5 a substance 15 with thermal energy discharging capacity, the intermediate insulating barrier 17 securing the device against the thermal runaway to avoid, if said thermal fuses with calories discharging have not been sufficient.

In particular by using the aforementioned means and elements, the implementation of a thermal management method of at least one said thermal means 5 in conformity with the invention is planned to operate as follows:
first the following will have to be found, placed close to each other (i.e. adjacent to each other):
   at least one such thermal means 5,
   and means 9 for thermally managing the thermal means, comprising at least one volume 13 wherein one said substance 15 with latent heat storage by phase change (such as a PCM) is arranged for exchanging heat with said thermal means while it is operating, each substance 15 having previously been chosen so as to have, mounted in the device 1, a boiling temperature at atmospheric pressure above which it passes in a gaseous state, in a superheating situation of the thermal means 5.
then, each volume 13 considered will have been connected to the above-mentioned discharge pipe 21/31, thus allowing, at a temperature higher than said boiling temperature at atmospheric pressure, an exhaust of the gas in which said substance has changed.

This being established, while the temperature of one or more thermal means 5 will become higher than the nominal operating limit temperature, the (each) substance 15 concerned will therefore be allowed to escape from said volume 13 where it was at a lower temperature. In this way, the (each) volume 13 concerned will be emptied of part of said substance 15.

It is again specified that the temperature of the thermal means 5 concerned, which is associated with the “limit temperature” of the substance(s) 15 and from or above which the nominal operation of this means 5 is altered, will, in the battery application mentioned above, be favourably between 15 and 60° C., preferably in the range of 28-38° C., as soon as the battery 3 is provided with a nominal and optimal operation between 25 and 35° C., all to within 10%.

The following situation may also be encountered in the context of the invention, namely the one where a substance 15 with a fusible phase change material must:
be able, in normal operation, to absorb the energy dissipation of thermal means 5 (in particular the battery cells) in order to homogenize the temperature in the module; the phase change will then be reversible and solid-liquid,
be able, when a thermal means 5 is failing (overheating) to absorb the energy released and vaporize, with then discharging through the defined exhaust paths (discharge pipe(s) 21.31; 23.28); the phase change will then be irreversible.

Such an operation questions the circulation part of the substance 15 between the spaces 13, since the material is not liquid.

A solution to overcome this problem, particularly in a battery application and by avoiding the presence of an “expansion vessel”, would be to combine this PCM material, which would then be (micro)-encapsulated in a fluid that also vaporizes at a fairly high temperature, which could be between 75 and 150° C. This fluid could then be different from a “commercial” PCM.

The encapsulated liquid to PCM ratio should be evaluated to maintain a low viscosity.

For example, the following can be provided for: Melting/Crystallization of the substance 15 material between 15 and 50° C.; Vaporization of the material between 75 and 150° C.

1. A thermal device comprising:
at least one thermal means dissipating thermal energy, in operation,
means for thermally managing the thermal means, comprising an enclosure having a volume in which a heat-absorbing substance is disposed for exchanging heat with said thermal means, in a nominal operating situation, and
a channeling between the volume of the enclosure and the outside environment,
characterized in that said channeling defines a discharge allowing, in an abnormal overheating situation of the thermal means, that at least a part of said substance is evacuated towards said outside environment further away from the thermal means than said volume is located with respect to said thermal means.

2. The thermal device according to claim 1, wherein said heat-absorbing substance is a latent heat storage element suitable for:
absorbing, by a phase change, a quantity of heat dissipated by the thermal means, and
being evacuated into said discharge, above a limit temperature, in a fluid state in which said substance has changed, during the phase change.

3. The thermal device according to claim 2, wherein the fluid state in which the latent heat storage element is transformed, above said limit temperature, is a gaseous phase.

4. The thermal device according to claim 1, wherein said heat-absorbing substance is capable of being in a gaseous phase so that, in said abnormal overheating situation of the thermal means, it can be evacuated in said gaseous phase to the outside through said discharge.

5. The thermal device according to claim 2, wherein said heat-absorbing substance has one of a phase change enthalpy of 60 kJ/kg or more, under atmospheric pressure and at the phase change temperature of said heat-absorbing substance.

6. The thermal device according to claim 1, wherein the means for thermally managing the thermal means further comprise at least one thermal insulating element interposed between the thermal means and the enclosure containing the heat absorbing substance.

7. The thermal device according to claim 3, wherein the discharge communicates with an upper part of said volume of the enclosure, so that a part of the latent heat gaseous storage element circulates therein, in said abnormal overheating situation of the thermal means.

8. The thermal device according to claim 1,
wherein the means for thermally managing the thermal means further comprise first and second latent heat storage substances,
which comprises at least two said thermal means, and
wherein the first and second latent heat storage substances are disposed respectively between said volume of the enclosure and said two thermal means.

9. The thermal device according to claim 1, which comprises at least two said thermal means between which at least one said enclosure is interposed in the volume of which the heat absorbing substance is arranged.

10. The thermal device according to claim 1,
which comprises two said enclosures in the volume of each of which one said heat absorbing substance is arranged, and
in which the means for thermally managing the thermal means further comprise a communicating vessels system which includes a communication for having said volumes of said two enclosures to communicate with each other.

11. The thermal device according to claim 2, wherein the heat-absorbing substance is capable of being in a liquid phase, in said nominal operating situation of the thermal means less hot than said abnormal overheating situation, and the or each enclosure is open at the bottom for a possible movement, in or out of said volume, of said heat absorbing substance that the enclosure contains, when the heat-absorbing substance is in the liquid phase.

12. The thermal device according to claim 3, wherein the or each enclosure is open at the top for a possible movement out of said volume of the heat absorbing substance contained in the enclosure, when the substance is in the gaseous phase.

13. The thermal device according to claim 1, wherein the volume of the enclosure or each enclosure communicates with the discharge through a communication which can be closed.

14. The thermal device according to claim 13, wherein the communication which can be closed comprises a wall, such as a valve, which opens for one of the following reasons: under effect of an increase in temperature or pressure, by tearing under pressure, by thermal destruction.

15. A method for thermally managing at least one thermal means dissipating thermal energy during operation, in which method the following elements are located near each other:
at least one thermal means.
means for thermally managing the thermal means, comprising at least one volume where a latent heat storage substance by phase change is disposed for exchanging heat with said thermal means while in operation, the latent heat storage substance having a boiling temperature at atmospheric pressure beyond which it passes into a gaseous phase, and
a channeling between the volume of the enclosure and the outside environment,
the method comprising possibly conducting said operation in an abnormal overheating situation of the thermal means, at a temperature higher than the boiling temperature at atmospheric pressure of said latent heat storage substance, and
the method further comprising exhausting the gas in which said latent heat storage substance has changed, during one said abnormal overheating situation, through said channeling and at said temperature above said boiling temperature at atmospheric pressure.
